(19) United States
(12) Patent Application Publication
(10) Pub. No.: US 2024/0420379 A1
(43) Pub. Date: Dec. 19, 2024

(54) ADAPTIVE COMPRESSION METHOD BASED ON BLOCK COMPRESSION, RELATED ELECTRONIC DEVICE, AND STORAGE MEDIUM

(71) Applicant: Bestechnic (Shanghai) Co., Ltd., Shanghai (CN)

(72) Inventors: Xiaohui LIU, Shanghai (CN); Yibo JIANG, Shanghai (CN)

(73) Assignee: Bestechnic (Shanghai) Co., Ltd., Shanghai (CN)

(21) Appl. No.: 18/798,888

(22) Filed: Aug. 9, 2024

Related U.S. Application Data
(63) Continuation of application No. PCT/CN2023/139338, filed on Dec. 18, 2023.

(30) Foreign Application Priority Data
Jun. 16, 2023 (CN) 202310718311.0

(51) Int. Cl. G06T 9/40

(52) U.S. Cl. CPC G06T 9/40

(57) ABSTRACT

In various aspects, methods, electronic devices, and non-transitory computer-readable medium for image compression are disclosed in the present disclosure. In some implementations, a disclosed method for image compression can comprise: determining a target pixel block in an image to be compressed; selecting one pixel block grouping mode from a plurality of pixel block grouping modes based on a direction of variation in pixel values within the target pixel block; and compressing the target pixel block by constructing a minimum value tree for the target pixel block based on the selected one pixel block grouping mode.

### CROSS-REFERENCE TO RELATED APPLICATIONS

This application is a continuation of International Application No. PCT/CN2023/139338, filed on Dec. 18, 2023, which claims the benefit of priority to Chinese Application No. 202310718311.0, filed on Jun. 16, 2023, both of which are incorporated herein by reference in their entireties.

### TECHNICAL FIELD

The present disclosure relates to the field of image processing technology, particularly to an adaptive compression method based on block compression, related electronic devices, and computer-readable storage media.

### BACKGROUND

Block compression technology is used for lossless compression of images and is applied in scenarios such as mobile devices, virtual reality, and gaming. It can significantly reduce storage and transmission costs while ensuring high-quality images. Block compression technology divides an image into several blocks for compression, and the compression process is aided by minimum value trees and bit count trees. Typical block compression technologies include Arm Frame Buffer Compression (AFBC), Adaptive Scalable Texture Compression (ASTC), Qualcomm's Universal Bandwidth Compression (UBWC) algorithm, Block Compression n (BCn) algorithm, and others.

However, conventional block compression technologies may encounter issues such as low compression efficiency and compression failures when dealing with pixel blocks with a wide numerical dynamic range.

### SUMMARY

In various aspects, methods, electronic devices, and non-transitory computer-readable medium for image compression are disclosed in the present disclosure.

In one aspect of the present disclosure, a method for image compression comprises: determining a target pixel block in an image to be compressed; selecting one pixel block grouping mode from a plurality of pixel block grouping modes based on a direction of variation in pixel values within the target pixel block; and compressing the target pixel block by constructing a minimum value tree for the target pixel block based on the selected one pixel block grouping mode.

In some implementations, selecting the one pixel block grouping mode comprises: calculating bit counts corresponding to the plurality of pixel block grouping modes, wherein each bit count represents a storage size required for a difference between a maximum pixel value and a minimum pixel value within each group of pixels; calculating function values corresponding to the plurality of pixel block grouping modes based on the bit counts by using a cost function; and selecting the one pixel block grouping mode corresponding to a minimum function value.

In some implementations, the method further comprises: detecting whether a pixel block group in the image is a High Dynamic Range (HDR) pixel block group; and determining each pixel block in the HDR pixel block group as one target pixel block.

In some implementations, the method further comprises: iterating pixel values within each pixel block in the pixel block group; and in response to the pixel values in one pixel block of the pixel block group being identical, determining that the pixel block group is the HDR pixel block group.

In some implementations, the method further comprises: iterating pixel values within each pixel block in the pixel block group; and in response to the pixel values in one pixel block of the pixel block group being greater than a first threshold or less than a second threshold, determining that the pixel block group is the HDR pixel block group.

In some implementations, the method further comprises: obtaining attribute information transmitted by a specified software module for the pixel block group; and determining whether the pixel block group is an HDR pixel block group based on the attribute information.

In some implementations, compressing the target pixel block comprises: performing fixed bit encoding on level nodes of a bit count tree for the target pixel block.

In some implementations, calculating the function values comprises: accumulating the bit counts corresponding to each pixel block grouping mode to obtain the function value for each pixel block grouping mode.

In some implementations, the method further comprises: the plurality of pixel block grouping modes comprises at least two of: partitioning the target pixel block into four subgroups by using a cross dividing method; partitioning the target pixel block into four subgroups by using a row dividing method; partitioning the target pixel block into four subgroups by using a column dividing method; and partitioning the target pixel block into four subgroups by using a parallel dividing method along a non-horizonal and non-vertical direction.

In some implementations, the method further comprises: in response to a decompression instruction, obtaining the selected one pixel block grouping mode of the minimum value tree for the target pixel block; and decompressing the target pixel block by using the minimum value tree based on the selected one pixel block grouping mode.

Another aspect of the present disclosure provides an electronic device, comprising: a processor; and a memory for storing executable instructions for programming the processor to: determine a target pixel block in an image to be compressed, select one pixel block grouping mode from a plurality of pixel block grouping modes based on a direction of variation in pixel values within the target pixel block, and compress the target pixel block by constructing a minimum value tree for the target pixel block based on the selected one pixel block grouping mode.

In some implementations, the processor is further programmed to: calculate bit counts corresponding to the plurality of pixel block grouping modes, wherein each bit count represents a storage size required for a difference between a maximum pixel value and a minimum pixel value within each group of pixels; calculate function values corresponding to the plurality of pixel block grouping modes based on the bit counts by using a cost function; and select the one pixel block grouping mode corresponding to a minimum function value.

In some implementations, the processor is further programmed to: detect whether a pixel block group in the image is a High Dynamic Range (HDR) pixel block group; and determine each pixel block in the HDR pixel block group as one target pixel block.

In some implementations, the processor is further programmed to: iterate pixel values within each pixel block in the pixel block group; and in response to the pixel values in one pixel block of the pixel block group being identical, determine that the pixel block group is the HDR pixel block group.

In some implementations, the processor is further programmed to: iterate pixel values within each pixel block in the pixel block group; and in response to the pixel values in one pixel block of the pixel block group being greater than a first threshold or less than a second threshold, determine that the pixel block group is the HDR pixel block group.

In some implementations, the processor is further programmed to: obtain attribute information transmitted by a specified software module for the pixel block group; and determine whether the pixel block group is an HDR pixel block group based on the attribute information.

In some implementations, the processor is further programmed to: perform fixed bit encoding on level nodes of a bit count tree for the target pixel block.

In some implementations, the processor is further programmed to: accumulate the bit counts corresponding to each pixel block grouping mode to obtain the function value for each pixel block grouping mode.

In some implementations, the plurality of pixel block grouping modes comprises at least two of: partitioning the target pixel block into four subgroups by using a cross dividing method; partitioning the target pixel block into four subgroups by using a row dividing method; partitioning the target pixel block into four subgroups by using a column dividing method; and partitioning the target pixel block into four subgroups by using a parallel dividing method along a non-horizonal and non-vertical direction.

In some implementations, the processor is further programmed to: in response to a decompression instruction, obtain the selected one pixel block grouping mode of the minimum value tree for the target pixel block; and decompress the target pixel block by using the minimum value tree based on the selected one pixel block grouping mode.

Another aspect of the present disclosure provides a non-transitory computer-readable medium stored in a memory and containing computer-executable instructions that, when executed by a processor, cause the processor to perform a method for image compression, the method comprising: determining a target pixel block in an image to be compressed; selecting one pixel block grouping mode from a plurality of pixel block grouping modes based on a direction of variation in pixel values within the target pixel block; and compressing the target pixel block by constructing a minimum value tree for the target pixel block based on the selected one pixel block grouping mode.

In some implementations, selecting the one pixel block grouping mode comprises: calculating bit counts corresponding to the plurality of pixel block grouping modes, wherein each bit count represents a storage size required for a difference between a maximum pixel value and a minimum pixel value within each group of pixels; calculating function values corresponding to the plurality of pixel block grouping modes based on the bit counts by using a cost function; and selecting the one pixel block grouping mode corresponding to a minimum function value.

In some implementations, the method further comprises: detecting whether a pixel block group in the image is a High Dynamic Range (HDR) pixel block group; and determining each pixel block in the HDR pixel block group as one target pixel block.

In some implementations, the method further comprises: iterating pixel values within each pixel block in the pixel block group; and in response to the pixel values in one pixel block of the pixel block group being identical, determining that the pixel block group is the HDR pixel block group.

In some implementations, the method further comprises: iterating pixel values within each pixel block in the pixel block group; and in response to the pixel values in one pixel block of the pixel block group being greater than a first threshold or less than a second threshold, determining that the pixel block group is the HDR pixel block group.

In some implementations, the method further comprises: obtaining attribute information transmitted by a specified software module for the pixel block group; and determining whether the pixel block group is an HDR pixel block group based on the attribute information.

In some implementations, compressing the target pixel block comprises: performing fixed bit encoding on level nodes of a bit count tree for the target pixel block.

In some implementations, calculating the function values comprises: accumulating the bit counts corresponding to each pixel block grouping mode to obtain the function value for each pixel block grouping mode.

In some implementations, the plurality of pixel block grouping modes comprises at least two of: partitioning the target pixel block into four subgroups by using a cross grouping; partitioning the target pixel block into four subgroups by using a row grouping; partitioning the target pixel block into four subgroups by using a column grouping; and partitioning the target pixel block into four subgroups by using parallel grouping along a non-horizonal and non-vertical direction.

In some implementations, the method further comprises: in response to a decompression instruction, obtaining the selected one pixel block grouping mode of the minimum value tree for the target pixel block; and decompressing the target pixel block by using the minimum value tree based on the selected one pixel block grouping mode.

Other aspects of the present disclosure can be understood by those skilled in the art in light of the description, the claims, and the drawings of the present disclosure.

### BRIEF DESCRIPTION OF THE DRAWINGS

The accompanying drawings, which are incorporated herein and form a part of the specification, illustrate aspects of the present disclosure and, together with the description, further serve to explain the principles of the present disclosure and to enable a person skilled in the pertinent art to make and use the present disclosure.

FIG. 1 is a schematic diagram of the minimum value tree in accordance with some implementations of the present disclosure.

FIG. 2 is a schematic diagram of the bit count tree provided in accordance with some implementations of the present disclosure.

FIG. 3 is a schematic diagram illustrating compression failure in accordance with some implementations of the present disclosure.

FIG. 4 is a structural schematic diagram of an electronic device in accordance with some implementations of the present disclosure.

FIG. 5 is a flowchart illustrating an adaptive compression method based on block compression in accordance with some implementations of the present disclosure.

FIG. 6 is a schematic diagram of the pixel block grouping mode in accordance with some implementations of the present disclosure.

FIG. 7 is another schematic diagram illustrating the pixel block grouping mode in accordance with some implementations of the present disclosure.

FIG. 8 is a schematic diagram of an adaptive compression device based on block compression in accordance with some implementations of the present disclosure.

The present disclosure will be described with reference to the accompanying drawings.

### DETAILED DESCRIPTION

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present disclosure.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

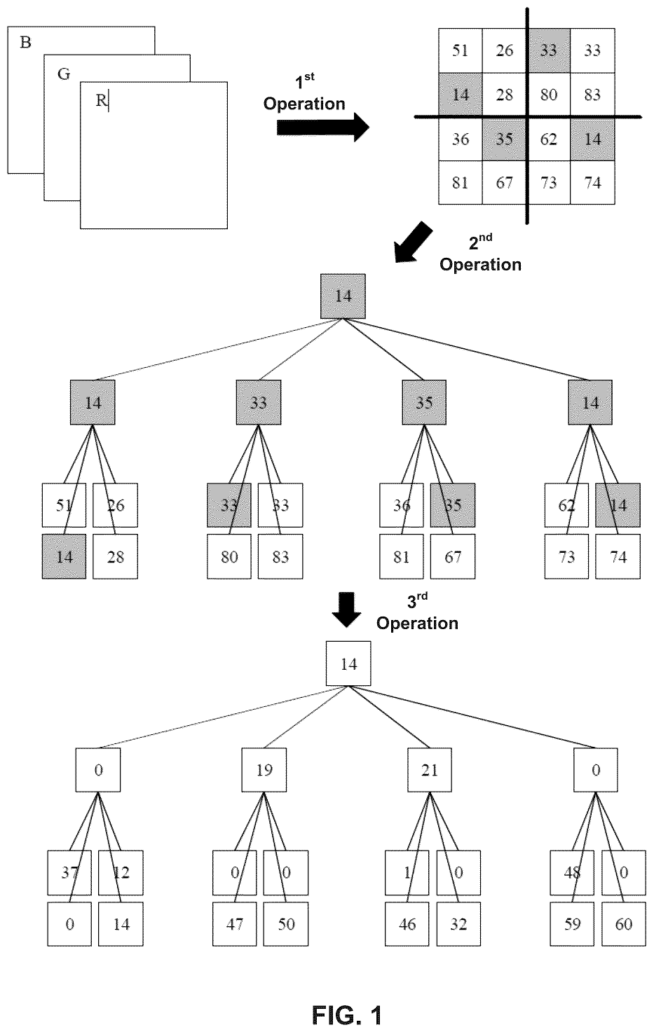

FIG. 1 is a schematic diagram of the minimum value tree in accordance with some implementations of the present disclosure. As shown in FIG. 1, in a first operation, each channel of the image can be divided into multiple 4×4 pixel blocks, each containing 16 pixels. For each 4×4 pixel block, it can be further divided into four 2×2 sub-blocks in a cross shape, and the minimum pixel value within each sub-block can be determined. The values in the gray boxes inside each sub-block in the upper right corner of FIG. 1 represent the minimum pixel values.

In a second operation, from the minimum pixel values of the 4 sub-blocks, the minimum pixel value within the 4×4 pixel block can be selected, and a minimum value tree can be constructed with the minimum pixel value as the root node. As shown in FIG. 1, the root node is the minimum pixel value within the 4×4 pixel block, which is 14. The root node's child nodes are the minimum pixel values within the 4 sub-blocks: 14, 33, 35, and 14, and the leaf nodes correspond to the 4 pixel values within each sub-block.

In a third operation, each leaf node is subtracted from its parent node, resulting in new leaf nodes. After processing all leaf nodes, each child node of the root node is subtracted from the root node to update the child nodes of the root node. This process generates the minimum value tree shown at the bottom of FIG. 1.

The root node of the minimum value tree can be referred to as the first-level node, representing the minimum pixel value within the pixel block corresponding to the minimum value tree. The child nodes of the root node can be called second-level nodes, representing the differences between the minimum pixel values within each sub-block and the minimum pixel value within the pixel block. The leaf nodes of the minimum value tree can be referred to as third-level nodes, representing the pixel values of individual pixels within the pixel block, along with the differences from the minimum pixel value within the pixel block and the minimum pixel value within their respective sub-blocks.

In this way, the pixel values within the original 4×4 pixel block can be represented using the minimum value tree. Since the pixel values in the minimum value tree are smaller than the pixel values within the pixel block, when stored in binary form, they can occupy less space, effectively achieving lossless compression (with a corresponding decompression process to obtain the lossless image).

For a 4×4 pixel block, after determining the corresponding minimum value tree, a bit count tree can also be created to record the storage space for pixel values within each node of the minimum value tree. Subsequently, the storage space recorded by the bit count tree can be used to retrieve pixel values within the minimum value tree.

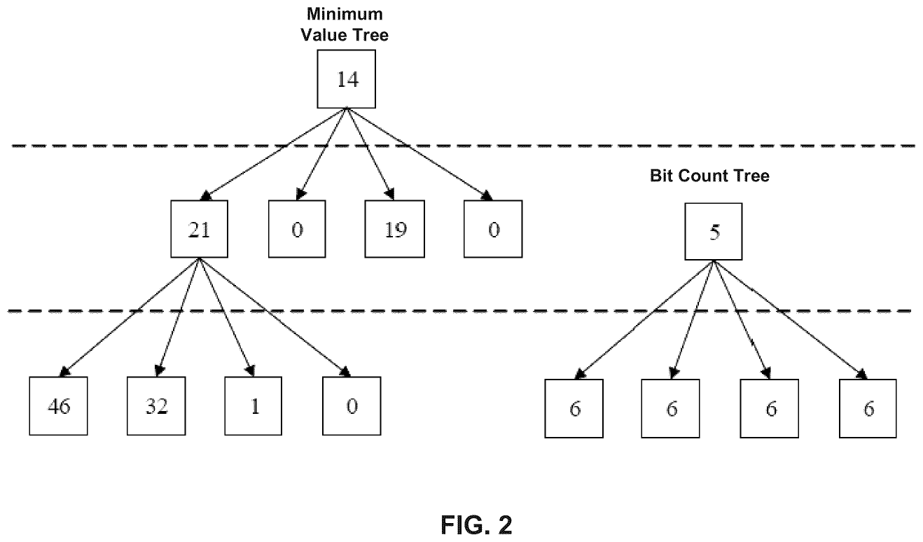

Referring to FIG. 2, a schematic diagram of the bit count tree is shown in accordance with some implementations of the present disclosure. As shown in FIG. 2, for the root node of the minimum value tree, a default-sized storage space is used to record it (e.g., for images with pixel values between 0 and 255, the pixel value of the root node is recorded using 8 bits of storage space). The bit count tree records the storage space required for the second-level and third-level nodes of the minimum value tree.

For the second-level nodes of the minimum value tree, the maximum value within these nodes can be selected to determine the storage space required for any value within the second-level nodes. Taking FIG. 2 as an example, the maximum value in the second-level nodes of the minimum value tree is 21, and it occupies 5 bits in binary storage. Therefore, the root node of the bit count tree is set to 5. Furthermore, for any four child nodes of a second-level node, the maximum value can be selected from these four third-level nodes to determine the required storage space. In FIG. 2, for example, the maximum value among the child nodes 46, 32, 1, and 0 of the second-level node 21 is 46, and it occupies 6 bits in binary storage. Hence, the corresponding nodes in the bit count tree for these four child nodes are set to 6.

Similarly, the binary storage space determined for the four child nodes of the second-level node 0 (the second second-level node) is 6 bits, for the four child nodes of the second-level node 19 is 6 bits, and for the four child nodes of the second-level node 0 (the fourth second-level node) is also 6 bits.

Further, to improve compression efficiency, two special modes can be used in block compression technology to represent 4×4 pixel blocks. In the first model, if all pixel values within the entire 4×4 pixel block are default values, only the root node of the bit count tree needs to be set to a special value to represent this situation. For example, if all pixel values in the 4×4 pixel block are 255, then the root node of the bit count tree corresponding to this pixel block is set to −2. In the second case, if all pixel values within the entire 4×4 pixel block are the same (but not default values), only the root node of the bit count tree needs to be set to a special value (e.g., set as −1), and the first-level node of the minimum value tree records that value to represent this situation.

To further compress the storage space occupied by the bit count tree, differential encoding can be used when the difference between the root node and leaf node values of the bit count tree is small. In this context, differential encoding refers to determining the storage space required for leaf nodes using differential calculations based on the storage space needed for the root node. Using FIG. 2 as an example, after differential encoding, the root node remains at 5, and the leaf nodes become 1, 1, 1, and 1. Furthermore, the root node values of the bit count tree can be stored using 3 bits, and the values of the differentially encoded leaf nodes can be stored using 1 bit.

However, for pixel blocks with a wide numerical dynamic range, compressing them using conventional block compression techniques may result in low compression efficiency and compression failures.

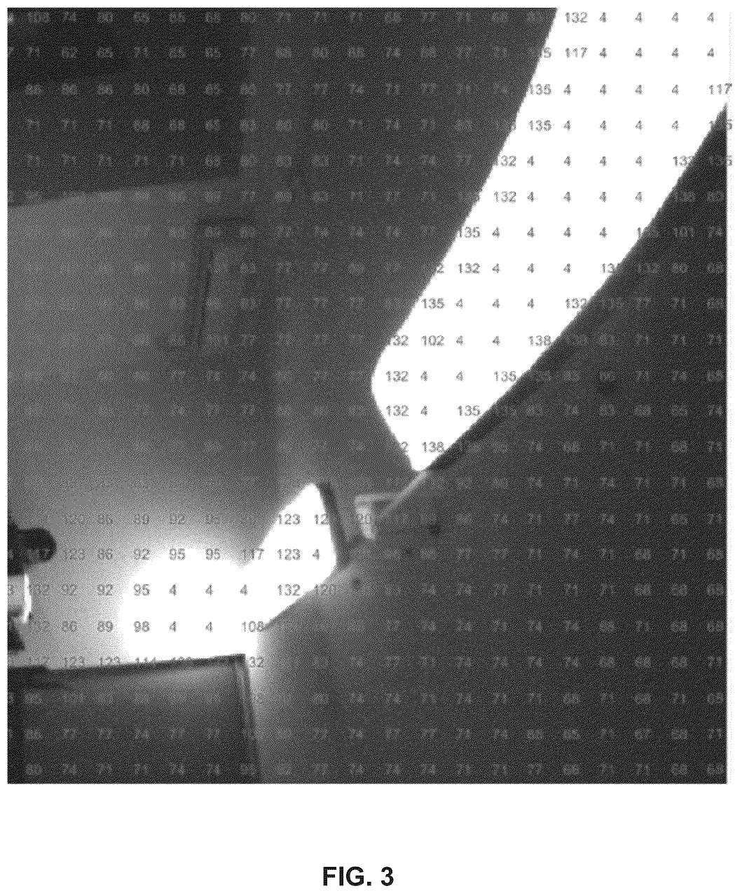

Referring to FIG. 3, a schematic diagram illustrating compression failures is shown in accordance with some implementations of the present disclosure. As shown in FIG. 3, the numbers in the image represent the average number of bits required for multiple pixel blocks (e.g., a 16×16 pixel area comprising sixteen 4×4 pixel blocks). The bright areas have the same pixel values within the same pixel block, allowing compression using existing block compression techniques, resulting in fewer bits to be used. However, in the dark areas surrounding the bright areas, the pixel values within the pixel blocks can have a wide range. In such cases, existing block compression techniques may not effectively compress the data, and the compressed data may still occupy a significant number of bits. The reason for compression failure in this context includes the additional storage space required when using differential encoding for the bit count tree.

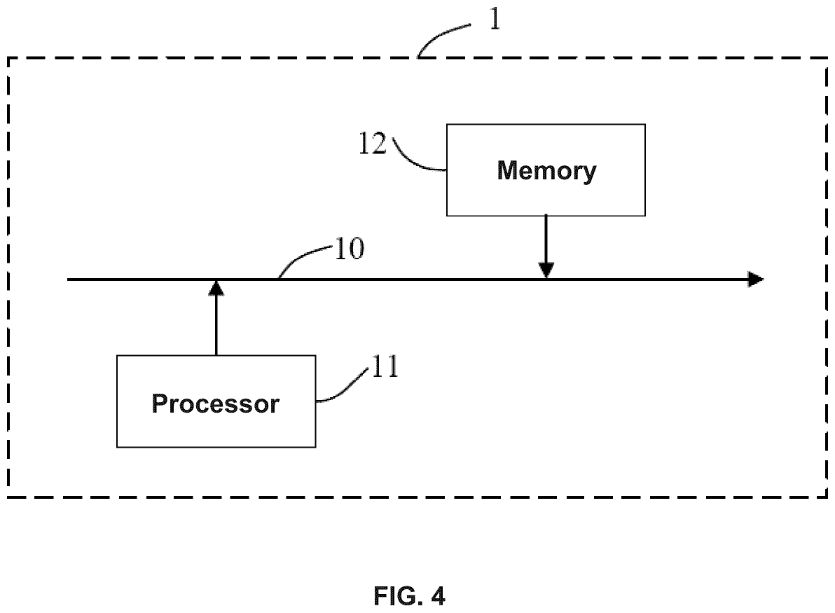

As shown in FIG. 4, the present disclosure can provide an electronic device 1, comprising at least one processor 11 and a memory 12. In FIG. 4, a single processor 11 is shown as an example. The processor 11 and memory 12 are connected via bus 10. Memory 12 stores instructions that can be executed by processor 11. The instructions are executed by processor 11 to enable electronic device 1 to perform some or all of the processes described in the implementations below.

In some implementations, electronic device 1 can be a host, smartphone, tablet, server, server cluster, or cloud computing center used to execute the adaptive compression method based on block compression. The following description focuses on the electronic device as the executing entity.

Memory 12 can be implemented using any type of volatile or non-volatile storage devices or combinations thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic storage, flash memory, hard disks, or optical disks.

The present disclosure further provides a computer-readable storage medium that stores computer programs. The computer program can be executed by processor 11 to perform the adaptive compression method based on block compression provided in the present disclosure.

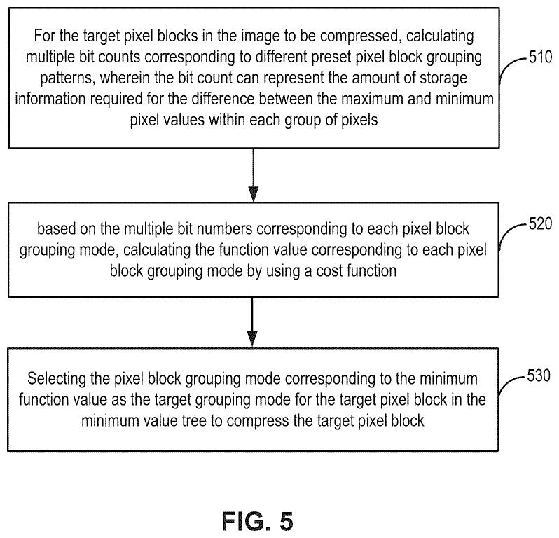

Referring to FIG. 5, a schematic flowchart of an adaptive compression method based on block compression is shown in accordance with some implementations of the present disclosure. As shown in FIG. 5, the method may include the following operations 510 to 530.

At operation 510: for the target pixel blocks in the image to be compressed, multiple bit counts corresponding to different preset pixel block grouping patterns can be calculated. The bit count can represent the amount of storage information required for the difference between the maximum and minimum pixel values within each group of pixels.

The pixel block grouping patterns can be used to represent different ways of dividing a 4×4 pixel block into sub-blocks. Block compression technology typically divides the top-left 4 pixels, bottom-left 4 pixels, top-right 4 pixels, and bottom-right 4 pixels into sub-blocks in a cross shape by default. However, due to the unpredictable direction of the changing of the pixel values within pixel blocks, using the default pixel block grouping pattern may lead to compression failures. To address this issue, the present disclosure can provide multiple pixel block grouping patterns, where each pixel grouping pattern can correspond to a specific direction of the changing of the pixel values within the pixel block.

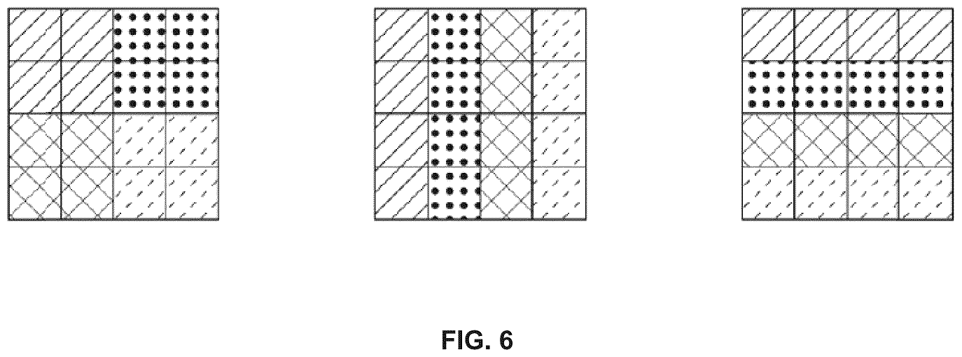

Referring to FIG. 6, a schematic representation of pixel block grouping patterns is shown in accordance with some implementations of the present disclosure. FIG. 6 shows three pixel block grouping patterns: the first one is the existing pixel block grouping pattern, where the pixel block is divided into four sub-blocks in a cross shape; the second pixel block grouping pattern divides the pixel block into groups based on each row, with each column of 4 pixels forming a sub-block; the third pixel block grouping pattern divides the pixel block into groups based on each column, with each row of 4 pixels forming a sub-block. In FIG. 6, pixels within the same sub-block can be represented with the same pattern.

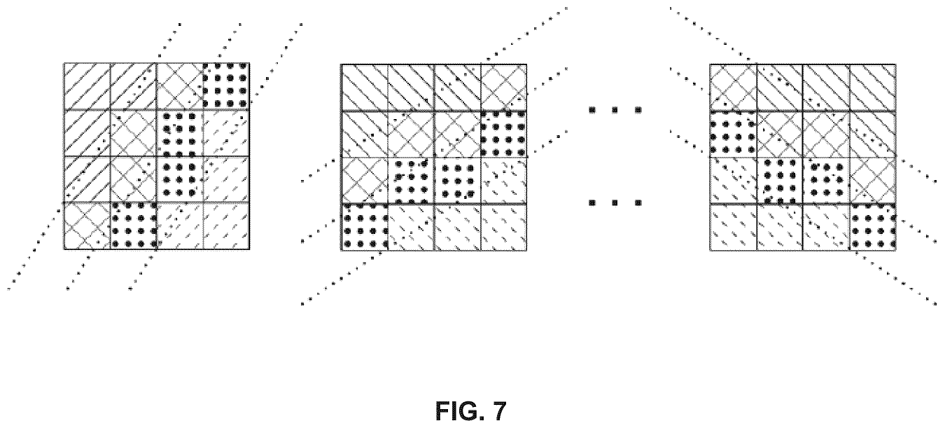

Referring to FIG. 7, a schematic representation of pixel block grouping patterns is shown in accordance with some implementations of the present disclosure. FIG. 7 shows multiple pixel block grouping patterns created by dividing the pixel block into multiple groups using three parallel dashed lines at various inclined angles. By changing the angle of the parallel dashed lines, various grouping patterns can be obtained. Pixels within the same sub-block in FIG. 7 are represented with the same pattern.

Additionally, multiple feasible grouping patterns can be generated through combinations and arrangements.

Depending on the implementation requirements, the present disclosure can configure multiple pixel block grouping patterns. For example, if the changing of the pixel values in the image is predominantly along the horizontal or vertical directions, the three pixel block grouping patterns shown in FIG. 6 can be configured. Alternatively, if the changing of the pixel values in the image becomes more complex, all feasible pixel block grouping patterns can be configured.

The image to be compressed can be a single-channel image (e.g., grayscale image) or a multi-channel image (e.g., RGB image, YUV image, etc.). If the image to be compressed is a single-channel image, the pixel blocks can be directly generated from the image, resulting in multiple 4×4 pixel blocks. If the image to be compressed is a multi-channel image, the image can be divided into channels, and multiple 4×4 pixel blocks can be generated separately from each channel. The image to be compressed can include any suitable data that can be equivalently represented as an image, such as depth maps, disparity maps, point cloud data, etc.

The electronic device can select a subset of pixel blocks from those generated from the image for compression using the adaptive compression method described in the present disclosure. For example, the electronic device can choose all the pixel blocks generated from the image as target pixel blocks.

Under each pixel block grouping pattern, the electronic device can calculate the difference between the maximum and minimum pixel values for each group of pixels and determine the corresponding storage information (e.g., bit count) based on this difference.

Exemplary, for any set of pixels, the corresponding number of bits is calculated based on the following formula (1):

$$b = ceil ( {log}_{2} ( 1 + max - min ) ) , \qquad ( 1 )$$

where “max” represents the maximum pixel value in a set of pixels, and “min” represents the minimum pixel value in a set of pixels, and “b” represents the number of bits corresponding to this set of pixels.

For a target pixel block, under any pixel block grouping mode, it can be divided into 4 sub-blocks, resulting in 4 sets of pixels, and accordingly, 4 sets of bit numbers can be calculated.

At operation 520: based on the multiple bit numbers corresponding to each pixel block grouping mode, the function value corresponding to each pixel block grouping mode can be calculated by using a cost function.

For any pixel block grouping mode, after obtaining the 4 sets of bit numbers corresponding to the target pixel block, the function value can be calculated through the cost function. The function value of the cost function is positively correlated with the storage cost of the target pixel block. In other words, the larger the function value, the larger the storage space occupied by the target pixel block under the pixel block grouping mode. The calculation method of the cost function can be configured as needed.

In some implementations, an electronic device can accumulate the multiple bit numbers corresponding to each pixel block grouping mode, thereby using the accumulated result as the function value of the cost function corresponding to that pixel block grouping mode.

Exemplarily, the cost function is represented by the following formula (2):

$$c = {b}_{0} + {b}_{1} + {b}_{2} + {b}_{3} , \qquad ( 2 )$$

where “c” is the function value, and “b₀,” “b₁,” “b₂,” and “b₃” are the bit numbers corresponding to the various groups of pixels in the target pixel block.

At operation 530: the pixel block grouping mode corresponding to the minimum function value can be selected as the target grouping mode for the target pixel block in the minimum value tree to compress the target pixel block.

After calculating the function values of the cost function for each pixel block grouping mode, the minimum function value can be determined from multiple function values. Compared to other pixel block grouping modes, the pixel block grouping mode corresponding to the minimum function value has a smaller dynamic range of values within the pixel block. At this point, the electronic device can determine that the pixel block grouping mode corresponding to the minimum function value is the one that maximizes compression efficiency when compressing the target pixel block. The electronic device can use this pixel block grouping mode corresponding to the minimum function value as the target grouping mode in the minimum value tree, generate a minimum value tree for the target pixel block, and thus compress the target pixel block.

Through the above operations, each pixel block grouping mode corresponds to a direction of variation in pixel values within a pixel block. By using multiple pixel block grouping modes and the cost function, the pixel block grouping mode that results in the minimum storage cost for the target pixel block in the image to be compressed can be determined adaptively as the target grouping mode for the target pixel block. This target grouping mode adapts to the direction of variation in pixel values within the target pixel block, thereby avoiding issues with low compression efficiency and compression failure.

In some implementations, before performing operation 510, a selection of some pixel blocks from the multiple pixel blocks partitioned from the image to be compressed can be made as the target pixel blocks.

The electronic device can separately examine whether pixel block groups in the image to be compressed are High Dynamic Range (HDR) pixel block groups. HDR pixel block groups have a wider dynamic range of pixel values. A pixel block group comprises multiple pixel blocks, and the size of the pixel block group can be configured as needed. For example, since the pixel block size is 4×4, the pixel block group size can be 8×8, 12×12, 16×16, 20×20, 24×24, etc.

In one aspect, if any pixel block group is not an HDR pixel block group, the electronic device can compress the pixel blocks within that pixel block group using conventional techniques.

In another aspect, if any pixel block group is an HDR pixel block group, the electronic device can identify multiple pixel blocks within the HDR pixel block group as target pixel blocks.

Through the above operations, the electronic device can select pixel blocks within HDR pixel block groups as target pixel blocks and compress them using specialized techniques, while compressing other pixel blocks using conventional techniques. The targeted compression of pixel blocks with a wide dynamic range of values in the image to be compressed reduces computational overhead and improves compression efficiency.

In some implementations, when detecting whether a pixel block group in the image to be compressed is an HDR pixel block group, the electronic device can, for each pixel block group, traverse the pixel values within each pixel block in the pixel block group, and determine if there is at least one pixel block with pixel values that are all the same. For example, in a single-channel 8-bit image, if all 16 pixels in a pixel block have pixel values of 0, 255, or some other single value, it can be determined that the pixel block group is an HDR pixel block group. Conversely, if there is no pixel block with pixel values that are all the same, it can be determined that the pixel block group is not an HDR pixel block group.

In another implementation, when detecting whether a pixel block group in the compressed image is an HDR pixel block group, the electronic device can, for each pixel block group, traverse the pixel values within each pixel block in the pixel block group and determine if there is at least one pixel block where all pixel values are either greater than a preset first threshold or less than a preset second threshold. The first and second thresholds can be configured based on empirical values, with the first threshold close to the upper limit of pixel values and the second threshold close to the lower limit of pixel values. For example, in a single-channel 8-bit image, the first threshold can be set to 245, and the second threshold can be set to 10.

In one aspect, if there is at least one pixel block where all pixel values are either greater than the first threshold or less than the second threshold, it can be determined that the pixel block is part of an HDR pixel block group. In another aspect, if there are no such pixel blocks, it can be determined that the pixel block group is not an HDR pixel block group.

In some implementations, when detecting whether a pixel block group in the compressed image is an HDR pixel block group, the electronic device can obtain attribute information transmitted by a specified software module for each pixel block group. This attribute information can indicate whether the pixel block group is an HDR pixel block group. It is noted that, the specified software module can be any combination of image processing modules upstream of the compression image's functional module, such as an Image Signal Processing (ISP) module, an Automatic Exposure Control (AEC) module, a feature extraction module, an optical flow extraction module, etc.

Based on the attribute information of the pixel block group, the electronic device can determine whether the pixel block group is an HDR pixel block group.

In some implementations, during the compression of target pixel blocks, fixed-bit encoding can be applied to various level nodes of the bit count tree for the target pixel block. In this case, the required number of bits for the root node and leaf nodes of the bit count tree is determined, and the values of the root node are stored using the required number of bits for the root node, while the values of the individual leaf nodes are stored using the required number of bits for each leaf node.

For image blocks with a wide dynamic range of values, using fixed bit encoding for various level nodes of the bit count tree can prevent compression failures caused by differential encoding.

In some implementations, after compressing the image, the compressed pixel blocks can be decompressed in subsequent application processes. The electronic device can respond to decompression instructions, retrieve the bit count tree corresponding to each pixel block in the image to be decompressed, and then read the values of the nodes of the minimum value trec corresponding to each pixel block from the bit count tree. Additionally, during the previous compression process, the target grouping mode for each pixel block can be recorded. During the decompression phase, the electronic device can retrieve the target grouping mode of the minimum value tree for each pixel block in the image to be decompressed. Based on the target grouping mode corresponding to each pixel block, the electronic device can decompress each pixel block.

Through the above operations, after compressing the image using the method described in the present disclosure, the compressed image can be adaptively decompressed.

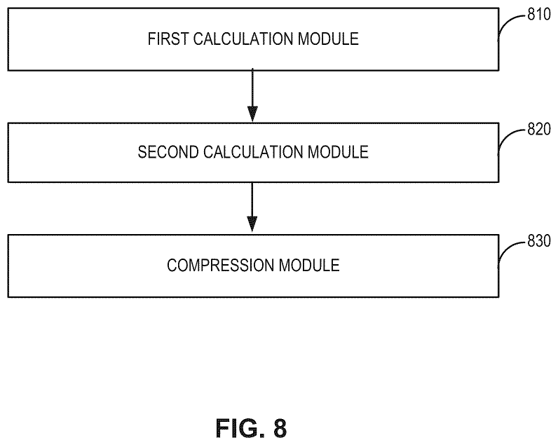

FIG. 8 is a block diagram of an adaptive compression device based on block compression technology according to some implementations of the present disclosure. As shown in FIG. 8, the device may include the following modules/

First calculation module 810 can be used to calculate, for the target pixel blocks in the image to be compressed, multiple bit numbers corresponding to various predefined pixel block grouping modes. The bit number represents the amount of storage information required for the difference between the maximum and minimum pixel values in each group of pixels.

Second calculation module 820 can be used to calculate the function values corresponding to each pixel block grouping mode based on the multiple bit numbers corresponding to each pixel block grouping mode using a cost function.

Compression module 830 can be used to select the pixel block grouping mode corresponding to the minimum function value as the target grouping mode for the target pixel block in the minimum value tree and compresses the target pixel block.

The specific implementation processes and functions of each module in the above disclosed device are detailed in the corresponding operations of the adaptive compression method based on block compression technology described above, thus, are not repeated here.

In some implementations provided in the present disclosure, the disclosed devices and methods can also be implemented through other means. The device implementations described above are illustrative. For example, the flowcharts and diagrams in the figures depict possible architectures, functionalities, and operations of devices, methods, and computer program products according to multiple implementations of the present disclosure. In this regard, each box in the flowchart or diagram may represent a part of a module, a program segment, or a piece of code, which can include one or more executable instructions for implementing specified logical functions.

In some alternative implementations, the functionalities or operations identified by the boxes shown in the figures may be performed out of the order shown in the figures. For example, two consecutive boxes may be performed substantially in parallel, or may be performed in a reverse order, depending on the functionality involved. Also, it should be noted that each box in the flowchart and/or diagram, and combinations of boxes in the flowchart and/or diagram, can be implemented by specialized hardware systems that perform the specified functions or operations, or by a combination of specialized hardware and computer instructions.

Furthermore, the functional modules in various implementations of the present disclosure can be integrated to form an independent entity, or can exist separately, or can be grouped and integrated to form multiple independent entities.

In some implementations, some functionalities can be implemented in the form of software functional modules and sold or used as standalone products. Such software functional modules can be stored in a computer-readable storage medium. Based on this understanding, the essential parts of the technical solution of the present disclosure, or parts of this technical solution, can be embodied in the form of a computer software product. The computer software product can be stored in a storage medium and includes several instructions for causing a computer device (e.g., a personal computer, a server, a network device, etc.) to perform all or part of the operations of the methods in various implementations of the present disclosure. The storage medium may include various media capable of storing program code, such as USB drives, portable hard drives, ROM, RAM, disks, or optical discs, among others.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations, but should be defined only in accordance with the following claims and their equivalents.

What is claimed is:

1. A method for image compression, comprising:
determining a target pixel block in an image to be compressed;
selecting one pixel block grouping mode from a plurality of pixel block grouping modes based on a direction of variation in pixel values within the target pixel block; and
compressing the target pixel block by constructing a minimum value tree for the target pixel block based on the selected one pixel block grouping mode.

2. The method of claim 1, wherein selecting the one pixel block grouping mode comprises:
calculating bit counts corresponding to the plurality of pixel block grouping modes, wherein each bit count represents a storage size required for a difference between a maximum pixel value and a minimum pixel value within each group of pixels;
calculating function values corresponding to the plurality of pixel block grouping modes based on the bit counts by using a cost function; and
selecting the one pixel block grouping mode corresponding to a minimum function value.

3. The method of claim 1, further comprising:
detecting whether a pixel block group in the image is a High Dynamic Range (HDR) pixel block group; and
determining each pixel block in the HDR pixel block group as one target pixel block.

4. The method of claim 3, further comprising:
iterating pixel values within each pixel block in the pixel block group; and
in response to the pixel values in one pixel block of the pixel block group being identical, determining that the pixel block group is the HDR pixel block group.

5. The method of claim 3, further comprising:
iterating pixel values within each pixel block in the pixel block group; and
in response to the pixel values in one pixel block of the pixel block group being greater than a first threshold or less than a second threshold, determining that the pixel block group is the HDR pixel block group.

6. The method of claim 3, further comprising:
obtaining attribute information transmitted by a specified software module for the pixel block group; and
determining whether the pixel block group is an HDR pixel block group based on the attribute information.

7. The method of claim 1, wherein compressing the target pixel block comprises:
performing fixed bit encoding on level nodes of a bit count tree for the target pixel block.

8. The method of claim 2, wherein calculating the function values comprises:
accumulating the bit counts corresponding to each pixel block grouping mode to obtain the function value for each pixel block grouping mode.

9. The method of claim 2, wherein the plurality of pixel block grouping modes comprises at least two of:
partitioning the target pixel block into four subgroups by using a cross dividing method;
partitioning the target pixel block into four subgroups by using a row dividing method;
partitioning the target pixel block into four subgroups by using a column dividing method; and
partitioning the target pixel block into four subgroups by using a parallel dividing method along a non-horizonal and non-vertical direction.

10. The method of claim 1, further comprising:
in response to a decompression instruction, obtaining the selected one pixel block grouping mode of the minimum value tree for the target pixel block; and
decompressing the target pixel block by using the minimum value tree based on the selected one pixel block grouping mode.

11. An electronic device, comprising:
a processor; and
a memory for storing executable instructions for programming the processor to:
determine a target pixel block in an image to be compressed,
select one pixel block grouping mode from a plurality of pixel block grouping modes based on a direction of variation in pixel values within the target pixel block, and
compress the target pixel block by constructing a minimum value tree for the target pixel block based on the selected one pixel block grouping mode.

12. The electronic device of claim 11, wherein the processor is further programmed to:
calculate bit counts corresponding to the plurality of pixel block grouping modes, wherein each bit count represents a storage size required for a difference between a maximum pixel value and a minimum pixel value within each group of pixels;
calculate function values corresponding to the plurality of pixel block grouping modes based on the bit counts by using a cost function; and
select the one pixel block grouping mode corresponding to a minimum function value.

13. The electronic device of claim 11, wherein the processor is further programmed to:
detect whether a pixel block group in the image is a High Dynamic Range (HDR) pixel block group; and
determine each pixel block in the HDR pixel block group as one target pixel block.

14. The electronic device of claim 13, wherein the processor is further programmed to:
iterate pixel values within each pixel block in the pixel block group; and
in response to the pixel values in one pixel block of the pixel block group being identical, determine that the pixel block group is the HDR pixel block group.

15. The electronic device of claim 13, wherein the processor is further programmed to:
iterate pixel values within each pixel block in the pixel block group; and
in response to the pixel values in one pixel block of the pixel block group being greater than a first threshold or less than a second threshold, determine that the pixel block group is the HDR pixel block group.

16. The electronic device of claim 13, wherein the processor is further programmed to:
obtain attribute information transmitted by a specified software module for the pixel block group; and
determine whether the pixel block group is an HDR pixel block group based on the attribute information.

17. The electronic device of claim 11, wherein the processor is further programmed to:
perform fixed bit encoding on level nodes of a bit count tree for the target pixel block.

18. The electronic device of claim 12, wherein the processor is further programmed to:
accumulate the bit counts corresponding to each pixel block grouping mode to obtain the function value for each pixel block grouping mode.

19. The electronic device of claim 12, wherein the plurality of pixel block grouping modes comprises at least two of:
partitioning the target pixel block into four subgroups by using a cross dividing method;
partitioning the target pixel block into four subgroups by using a row dividing method;
partitioning the target pixel block into four subgroups by using a column dividing method; and
partitioning the target pixel block into four subgroups by using a parallel dividing method along a non-horizonal and non-vertical direction.

20. A non-transitory computer-readable medium stored in a memory and containing computer-executable instructions that, when executed by a processor, cause the processor to perform a method for image compression, the method comprising:
determining a target pixel block in an image to be compressed;
selecting one pixel block grouping mode from a plurality of pixel block grouping modes based on a direction of variation in pixel values within the target pixel block; and
compressing the target pixel block by constructing a minimum value tree for the target pixel block based on the selected one pixel block grouping mode.
